(19) United States
(12) Patent Application Publication
(10) Pub. No.: US 2006/0158345 A1
(43) Pub. Date: Jul. 20, 2006

(54) Single-band remote control method and apparatus for multiple frequency groups of devices

(75) Inventor: Chung-Ping Chi, Chung Ho City (TW)

Correspondence Address: HDSL, 4331 STEVENS BATTLE LANE, FAIRFAX, VA, 22033, US

(73) Assignee: Topseed Technology Corp.

(21) Appl. No.: 11/034,014

(22) Filed: Jan. 13, 2005

(51) Int. Cl. G08C 19/00

(52) U.S. Cl. 340/825.69; 341/176; 340/825.72

(57) ABSTRACT

A single-band remote control for controlling different categories of remote devices, and multiple remote devices of the same category, the remote control has a plurality of control keys divided into a plurality of frequency groups. The control keys of the same frequency group are operative to generate and transmit control signals with different identification data at the same frequency, while the control keys of different frequency group are operative to generate control signals with different frequencies within the same frequency band. Thereby, different types of remote devices and/or multiple remote devices of the same category can be controlled by the same remote control.

### BACKGROUND OF THE INVENTION

The present invention relates in general to a single-band remote control method and a remote control apparatus for a multiple frequency groups of devices, and more particularly, and more particularly, to use a remote control which includes a plurality of control keys divided into a plurality of frequency groups that generate control signals with different frequencies and identification data for communication different categories of remote devices, and/or multiple devices of the same categories.

The advanced development of wireless transmission technologies such as typical remote controls, wireless keyboards and radio-frequency (RF) wireless transmission launches the digital control of home appliance. The remote control allows the user to control multiple remote devices such as digital home appliance, computers, open/shut system of doors and windows, security system and monitor system in various locations.

The typical remote control operates within a predetermined frequency band to control a remote apparatus within a specific distance. The universal remote control available in the market also operates within a specific range of frequency to directly control various remote devices that have different identification data, such as television, DVD player. Alternatively, the identification data or codes are saved within respective control keys perform control of the remote devices by the corresponding control keys. However, the conventional remote control apparatus can only remotely control a limited number of different electronic products. For example, the same electronic products such as televisions cannot be controlled by the same remote control. Therefore, when more than one remote control is used simultaneously, signal interference is inevitable.

### BRIEF SUMMARY OF THE INVENTION

To resolve the drawbacks of the conventional remote control, the single-band remote control is designed for controlling different categories of remote devices, and multiple remote devices of the same category. The remote control includes a plurality of control keys divided into a plurality of frequency groups. The control keys of the same frequency group are operative to generate and transmit control signals with different identification data at the same frequency, while the control keys of different frequency group are operative to generate control signals with different frequencies within the same frequency band. Thereby, different types of remote devices and/or multiple remote devices of the same category can be controlled by the same remote control.

Accordingly, the remote control has a plurality of control keys divided into a plurality of frequency groups. The control keys of the same frequency group are operative to generate and transmit control signals with different identification data at the same frequency, while the control keys of different frequency group are operative to generate control signals with different frequencies within the same frequency band. Thereby, different types of remote devices and/or multiple remote devices of the same category can be controlled by the same remote control.

### BRIEF DESCRIPTION OF THE DRAWINGS

These as well as other features of the present invention will become more apparent upon reference to the drawings therein:

FIG. 1 shows a remote control;

FIG. 2 shows a remote control system;

FIG. 3 shows the operation process of the remote control system;

FIG. 4 shows another embodiment of a remote control system; and

FIG. 5 shows another embodiment of a remote control system.

### DETAILED DESCRIPTION OF THE INVENTION

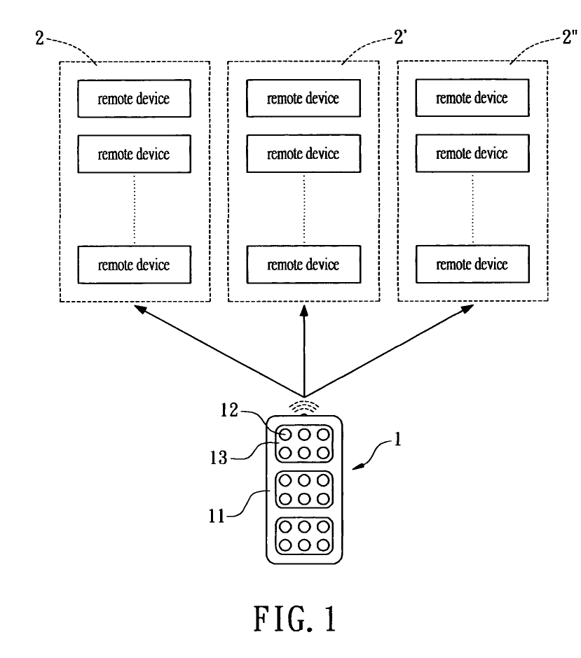

FIG. 1 illustrates a remote control system that includes a remote control 1 for controlling a group of remote devices 2, 2′ and 2″ having a single frequency band.

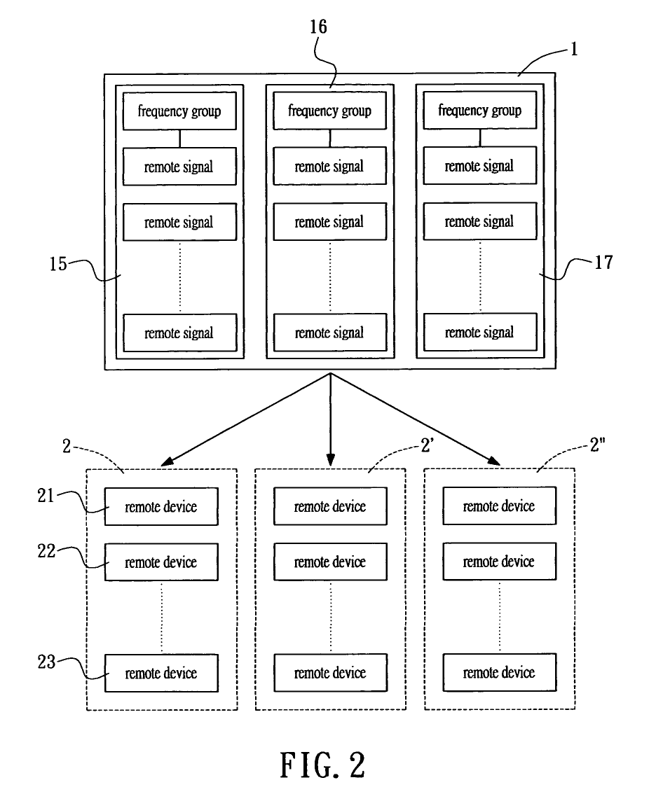

The remote control 1 includes a RF signal transmitter, a wireless keyboard, or a typical remote control that generates a control signal to control the remote device groups 2, 2′ and 2″ each comprising the remote devices 21, 22 and 23. Each of the remote device groups 2, 2′ and 2″ may comprise a plurality of remote controls. For example, the group 2 may comprise the same type of remote devices 21, 22 and 23. The remote control 1 has a main body 11 and a plurality of control keys 12 arranged on a control panel of the main body 11. The control keys 12 can be divided into a plurality of groups each containing a plurality of control keys 13. In the example as shown in FIG. 2, the control panel includes three frequency groups 15, 16 and 17 of control keys 13, each being operative at a specific frequency within a single frequency band of the remote control 1.

The control signal transmitted by the remote control 1 can be generated by the control key 13 in any frequency group 15, 16 and 17, and each control signal is composed of a preset frequency and an identification data (ID). The frequency groups 15, 16 and 17 are operative for generating control signals with three different frequencies within the single frequency band of the remote control 1. The control signals transmitted by the frequency groups 15, 16 and 17 are received by the groups of remote devices 2, 2′ and 2″, respectively. In one embodiment, although the control signals generated by the control keys 13 of the same frequency group 15 have the same frequency, by encoding the control signals with different identification data, the control signals can be used to identify and control different remote devices 21, 22 and 23 of the same group 2. In this manner, a single remote control 1 having a single frequency band can be used to control different categories of remote devices and the same type of remote devices.

The identification code for the remote devices 21, 22 and 23 are generated from random by the control keys 12 and a software, and each control key 12 is preset with a specific identification data for controlling a specific remote device.

As mentioned above, the remote devices to be controlled by the remote control are divided into a plurality of groups 2, 2′ and 2″, each having a plurality of remote devices 21, 22 and 23 operable at a specific frequency.

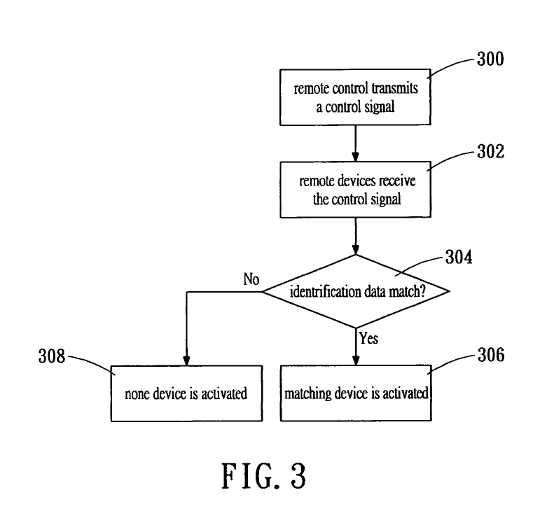

FIG. 3 shows an operation process of remotely controlling the groups of remote devices 2, 2′ and 2″ by the remote control 1.

In step 300, a remote control 1 that includes a plurality of control key groups is provided, and one of the control key 12 is pressed to generate and transmit a control signal.

In step 302, the control signal is received by one of the remote device groups 2, 2′ and 2″ that operable at the frequency the same as that of the control signal. The identification data is then compared with the pre-programmed or pre-configured identification data of the remote devices 15, 16 and 17 of the operable group in step 304. In step 306, the remote device 15, 16 or 17 with the identification data matching with the control signal is then activated in step 306.

If no matching identification data can be found from the remote devices 15, 16 and 17, instead of activating the matching remote device in step 30, no remote devices 15, 16 and 17 will be activated in step 308.

In addition to the operation process as shown in FIG. 3, the remote devices 15, 16 and 17 in multiple groups 2, 2′ and 2″ can be activated simultaneously by pressing more than one control keys 12 at the same time.

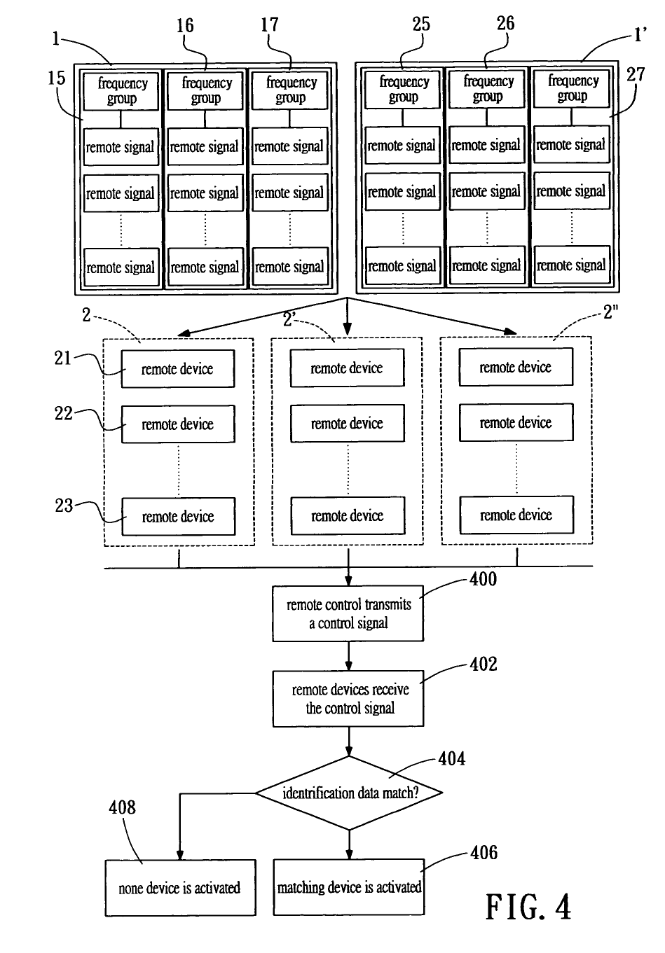

In the example as shown in FIG. 4, two remote controls 1 and 1′ are operative to control the groups of remote devices 2, 2′ and 2″. That is, by pressing any control key 12 of the remote control 1 or 1′, a control signal is generated and transmitted to the remote devices in the groups 2, 2′ and 2″ in step 400. When any group of remote devices 2, 2′ and 2″ has the operable frequency the same as that of the control signal in step 402, the identification data carried by the control signal is compared to the identification data of the remote devices 21, 22 and 23 of the matching group in step 404. When the identification data of the control signal matches any of the remote devices 21, 22 and 23, the matching device is activated or inactivated in step 406. If no matching identification data can be found from the remote devices 21, 22 and 23 of the matching group, then none of the remote devices of the matching group will be activated or inactivated in step 408.

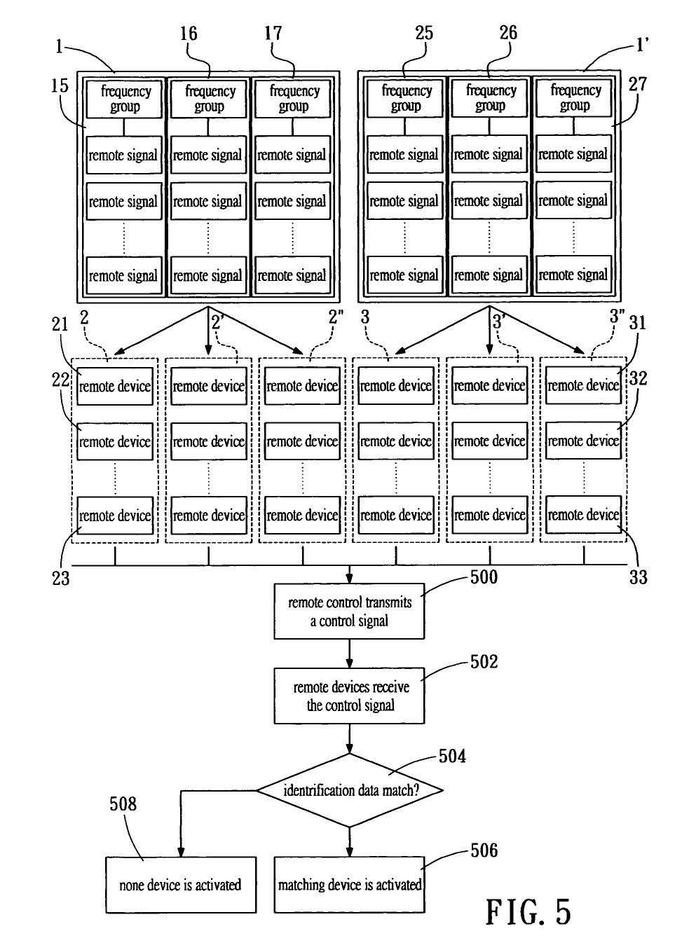

In FIG. 5, two remote controls 1 and 1′ are used to control the groups of remote devices 2, 2′, 2″ and 3, 3, 3″, respectively. In this example, the remote controls 1 and 1′ have different frequency bands for controlling the groups 2, 2′, 2″ and 3, 3′, 3″ of remote devices at different frequencies in two different bands, respectively. Each of the groups 2, 2′ and 2″ comprises remote devices 21, 22 and 23 operable at the same frequency and having distinct identification data, and each of the groups 3, 3′ and 3″ comprises remote devices 31, 32 and 33 also operable at the same frequency but having different identification data. The user can thus remotely control any or all of the remote devices by pressing the keys of the remote controls 1 and/or 1′. In step 500, a control key of the remote controls 1 and 1′ is pressed to generate a control signal. In step 502, the frequency and identification data of the control signal is compared. If any matching identification data is found in step 504, the remote device having the matching identification data is activated or inactivated in step 506; otherwise, no remote device is activated/inactivated by the control signal in step 508.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. A remote control method using a remote control having a plurality of control keys on a control panel thereof to control a plurality of groups of remote devices, the method comprising:
pressing at least one control key to generate a control signal carrying an identification data at a specific frequency;
comparing the frequency of the control signal with operation frequencies of the groups of remote devices, so as to find a matching group;
comparing identification data of the remote devices of the matching group, so as to find a matching remote device; and
activating or inactivating the matching remote device.

2. The method of claim 1, further comprising dividing the control keys into a plurality of groups operative to generate control signals at different frequencies within a single frequency band.

3. The method of claim 1, further comprising configuring each of the control keys of the remote control responsible for controlling a respective one of the remote devices.

4. A method of remotely controlling a plurality of groups of remote devices, comprises:
providing at least one remote control having a plurality of control keys;
dividing the control keys into a plurality of frequency groups each being responsible to generate a control signal at a frequency operable for one respective group of the remote devices and an identification data matching with an identification data of one remote device of the respective group; and
pressing at least one of the control keys to control at least one of the remote devices.

5. The method of claim 4, wherein the remote control has a single frequency band and the operable frequencies of the remote devices are within the single frequency band.

6. A remote-control system, comprising:
at least one single-band remote control, which comprises:
a plurality of control keys divided into a plurality of frequency groups for generating control signals with different frequencies, wherein each frequency groups include a plurality of the control keys for generating control signals with different identification data; and
a plurality of remote devices each being controlled by respective one of the control keys.

7. The system of claim 6, wherein the control signals generated by different frequency groups have different frequencies within a single frequency band.

8. The system of claim 6, wherein the same category of remote devices is controlled by the same frequency group of control keys.
